(19) United States
(12) Patent Application Publication
(10) Pub. No.: US 2022/0138557 A1
(43) Pub. Date: May 5, 2022

(54) Deep Hybrid Graph-Based Forecasting Systems

(71) Applicant: Adobe Inc., San Jose, CA (US)

(72) Inventors: Ryan A. Rossi, Santa Clara, CA (US); Hongjie Chen, Blacksburg, VA (US); Kanak Vivek Mahadik, San Jose, CA (US); Sungchul Kim, San Jose, CA (US)

(73) Assignee: Adobe Inc., San Jose, CA (US)

(21) Appl. No.: 17/089,157

(22) Filed: Nov. 4, 2020

(51) Int. Cl. G06N 3/08; G06N 3/04; G06F 16/2458

(52) U.S. Cl. CPC G06N 3/08; G06F 16/2474; G06N 3/04

(57) ABSTRACT

In implementations of deep hybrid graph-based forecasting systems, a computing device implements a forecast system to receive time-series data describing historic computing metric values for a plurality of processing devices. The forecast system determines dependency relationships between processing devices of the plurality of processing devices based on time-series data of the processing devices. Time-series data of each processing device is represented as a node of a graph and the nodes are connected based on the dependency relationships. The forecast system generates an indication of a future computing metric value for a particular processing device by processing a first set of the time-series data using a relational global model and processing a second set of the time-series data using a relational local model. The first and second sets of the time-series data are determined based on a structure of the graph.

### BACKGROUND

In cloud-based systems, computing resources of individual computing devices are aggregated into a group and made available for consumption via a network. These computing resources commonly include processing capacity, data storage capacity, and so forth. Demand for the computing resources made available via the network is dynamic and frequently increases and decreases substantially. As a result, predicting this demand accurately presents a significant challenge for cloud-based systems. For example, adding additional computing devices to the group to upscale available computing resource capacity based on an inaccurate prediction is inefficient and increases operating costs. Similarly, removing computing devices from the group to downscale available capacity based on an inaccurate prediction results in capacity shortages and service disruptions. Other types of systems such as systems that are not necessarily cloud-based face similar challenges in various forecasting scenarios.

### SUMMARY

Techniques and systems are described for deep hybrid graph-based forecasting. In an example, a computing device implements a forecast system to receive time-series data describing historic computing metric values for a plurality of processing devices. The forecast system determines dependency relationships between processing devices of the plurality of processing devices based on time-series data of the processing devices. In one example, the forecast system determines a dependency relationship between first and second processing devices of the plurality of processing devices based on similarities between time-series data of the first and second processing devices.

The forecast system represents time-series data of each processing device of the plurality of processing devices as a node of a graph. For example, the nodes are connected based on the dependency relationships. The forecast system generates an indication of a future computing metric value for a particular processing device by processing a first set of the time-series data using a relational global model and processing a second set of the time-series data using a relational local model. The first set includes time-series data represented by all connected nodes of the graph and the second set includes time-series data represented by a particular node that represents time-series data of the particular processing device and time-series data of nodes of the graph that are connected to the particular node.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for deep hybrid graph-based forecasting as described herein.

FIG. 2 depicts a system in an example implementation showing operation of a forecast module for deep hybrid graph-based forecasting.

FIGS. 3A, 3B, and 3C illustrate an example of generating an indication of a future computing metric value for a particular processing device included in a group of processing devices.

FIG. 4 is a flow diagram depicting a procedure in an example implementation in which time-series data is received describing historic computing metric values for a plurality of processing devices and an indication of a future computing metric value for a particular processing device is generated.

FIG. 5 illustrates an example system that includes an example computing device that is representative of one or more computing systems and/or devices for implementing the various techniques described herein.

### DETAILED DESCRIPTION

### Overview

Demand for cloud-based computing resources of a group of processing devices is difficult to accurately forecast due to the dynamic nature of the demand for such resources. Conventional systems for forecasting this demand do so by processing historic workload data of each processing device in the group individually and also processing historic workload data of all the processing devices in the group collectively. These conventional systems are computationally expensive and predictions made by these systems are inaccurate.

To overcome the limitations of conventional systems, techniques and systems are described for deep hybrid graph-based forecasting. For example, a computing device implements a forecast system to receive time-series data describing historic computing metric values for a plurality of processing devices. In one example, the historic computing metric values are CPU usage value of the plurality of processing devices. In another example, the historic computing metric values are memory usage values of the plurality of processing devices.

The forecast system determines dependency relationships between processing devices of the plurality of processing devices based on time-series data of the processing devices. For example, the forecast system determines a dependency relationship between first and second processing devices of the plurality of processing devices based on similarities between time-series data of the first and second processing devices. In an example in which the first and second processing devices have the dependency relationship, the forecast system is capable of leveraging time-series data of the first processing device to forecast future computing metric values for the second processing device and/or leveraging time-series data of the second processing device to predict future computing metric values for the first processing device.

The forecast system represents time-series data of each processing device of the plurality of processing devices a node of a graph. The nodes are connected based on the dependency relationships. Continuing the previous example, a node representing time-series data of the first processing device and a node representing time-series data of the second processing device are connected by an edge of the graph because the first and second processing devices have the dependency relationship. In another example in which the first and second processing devices do not have the dependency relationship, the node representing the time-series data of the first processing device is not connected to the node representing the time-series data of the second processing device.

By forming the graph in this manner, the forecast system encodes relationships between processing devices of the plurality of processing devices in a structure of the graph. The forecast system uses the graph to determine sets of time-series data which the forecast system processes with a relational global model and a relational local model to generate an indication of a future computing metric value for a particular processing device. To do so in one example, the forecast system processes a first set of the time-series data using the relational global model and processes a second set of the time-series data using the relational local model. The first set includes time-series data represented by all connected nodes of the graph and the second set includes time-series data represented by a particular node that represents time-series data of the particular processing device and time-series data represented by nodes of the graph that are connected to the particular node. The forecast system generates the indication of the future computing metric value for the particular processing device by combining outputs from the relational global model and the relational local model.

For example, the forecast system generates the indication of the future computing metric value for the particular processing device as part of generating a probabilistic forecast of future computing metric values for each processing device of the plurality of processing devices. In this example, the probabilistic forecast includes indications of multiple future computing metric values for each processing device having time-series data represented by a node of the graph. Accordingly, the probabilistic forecast includes indications of future computing metric values for the particular processing device that are forecast in temporal increments which are one step ahead, two steps ahead, three steps ahead, four steps ahead, five steps ahead, and so forth.

By leveraging the structure of the graph to forecast computing metric values, the described systems generate predictions of future computing metric values with greater accuracy than conventional systems. Unlike conventional systems which explicitly assume that each processing device of a group of processing devices is unrelated to every other processing device included in the group, the described systems utilize dependency relationships of processing devices for predicting future computing metric values. This improves accuracy of predictions and decreases computational costs of generating the predictions using conventional techniques. These improvements are verified and validated on multiple real-world datasets.

Forecasts of computing metric values generated by the described systems are usable to improve cloud-based resource provisioning which facilitates resource optimization and reduces operational costs. For example, improvements in accuracy and efficiency of forecasts made by the described systems facilitates automatic provisioning of resources as well as opportunistic workload scheduling. Further, the described systems are robust and scalable such that these systems are usable to improve accuracy of efficiency of demand forecasting and other forecasting in a variety of different scenarios in which predictions are generated based on multi-dimensional time-series data.

In the following discussion, an example environment is first described that employs examples of techniques described herein. Example procedures are also described which are performable in the example environment as well as other environments. Consequently, performance of the example procedures is not limited to the example environment and the example environment is not limited to performance of the example procedures.

Example Environment

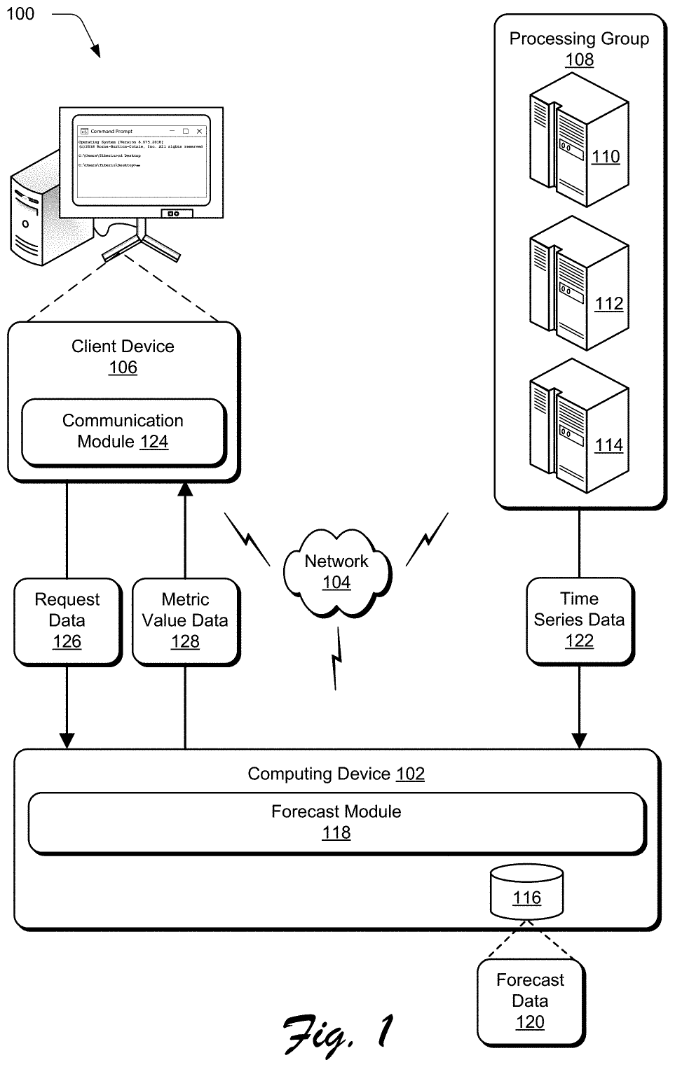

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a client device 106 and a processing group 108 which are both connected to the network 104. The processing group 108 includes processing devices 110-114. Although illustrated as including three processing devices, it is to be appreciated that in many examples the processing group 108 includes thousands of processing devices. In one example, the processing group 108 is scalable cloud-based processing capacity which is increasable by adding an additional processing device and which is decreasable by removing one of the processing devices 110-114.

The computing device 102 includes a storage device 116 and a forecast module 118. The storage device 116 is illustrated to include forecast data 120 which the forecast module 118 generates by processing time-series data 122. The time-series data 122 describes historic computing metric values of the processing devices 110-114. For example, the historic computing metric values include historic CPU usage values of each of the processing devices 110-114, historic memory usage values of each of the processing devices 110-114, historic power consumption values of each of the processing devices 110-114, and so forth.

As shown, the computing device 102 receives the time-series data 122 from the processing group 108 via the network 104. In one example, the computing device 102 receives the time-series data 122 in discrete increments of time such as receiving updated time-series data 122 every minute, every five minutes, every 30 minutes, etc. In another example, the computing device receives the time-series data 122 from the processing group 108 continuously and in substantially real time.

The forecast module 118 processes the time-series data 122 to determine dependency relationships between the processing devices 110-114 of the processing group 108. For example, if processing device 110 and processing device 114 have a dependency relationship, then time-series data 122 of the processing device 110 is similar to time-series data 122 of the processing device 114. In an example in which the processing devices 110, 114 have the dependency relationship, the time-series data 122 of the processing device 110 is leverageable to predict a future computing metric value for the processing device 114 and/or the time-series data 122 of the processing device 114 is usable to predict a future computing metric value for the processing device 110.

The forecast module 118 determines the dependency relationships between the processing devices 110-114 and then forms a graph having nodes that each represent a processing device of the processing group 108. For example, each of the nodes of the graph represents one of the processing devices 110-114 and its time-series data 122. The forecast module 118 connects the nodes of the graph based on the determined dependency relationships between the processing devices 110-114 such that nodes of the graph representing processing devices having a dependency relationship are connected and nodes of the graph representing processing devices that do not have a dependency relationship are not connected. The forecast module 118 generates the forecast data 120 based on the connected nodes of the graph. To do so, the forecast module 118 processes sets of the of the time-series data 122 using a relational global model and a relational local model for each node of the graph.

For example, and for each node of the graph, the forecast module 118 processes a first set of the time-series data 122 using the relational global model. In this example, the first set includes time-series data 122 of all connected nodes of the graph. Continuing this example, the forecast module 118 processes a second set of the time series data 122 using the relational local model. For a particular node of the graph, the second set of the time-series data 122 includes the time-series data 122 of the particular node and the time-series data 122 of all nodes connected to the particular node by edges of the graph.

The forecast module 118 generates the forecast data 120 by combining outputs of the relational global model and the relational local model. For example, the forecast data 120 describes a probabilistic forecast of future computing metric values for the processing devices 110-114. In one example, the probabilistic forecast includes a single future computing metric value for each of the processing devices 110-114. In another example, the probabilistic forecast includes multiple future computing metric values for each of the processing devices 110-114. In this example, the probabilistic forecast includes future computing metric values for the processing device 110 which are one step in the future, two steps in the future, three steps in the future, and so forth. The forecast module 118 accesses the forecast data 120 to generate indications of future computing metric values for a particular processing device of the processing devices 110-114.

The client device 106 is illustrated to include a communication module 124 which the client device 106 implements to transmit and receive data via the network 104. In an example, the client device 106 implements the communication module 124 to transmit request data 126 to the computing device 102 via the network 104. In this example, the request data 126 describes a request for a future computing metric value of the particular processing device of the processing devices 110-114. The forecast module 118 receives the request data 126 and determines the future computing metric value of the particular processing device by accessing the forecast data 120. The forecast module 118 generates metric value data 128 that describes an indication of the future computing metric value for the particular processing device and transmits the metric value data 128 to the client device 106 via the network 104.

Consider an example in which the client device 106 is an administrator of the processing group 108. In this example, the client device 106 is responsible for adding an additional processing device to the processing group 108 when the processing devices 110-114 do not have enough processing capacity to meet a cloud-based capacity demand. Similarly, the client device 106 is responsible for removing one of the processing devices 110-114 from the processing group 108 when the processing devices 110-114 have more than enough processing capacity to meet the cloud-based capacity demand.

Continuing the previous example, the client device 106 leverages the metric value data 128 as part of updating or optimizing computing resources of the processing group 108. For example, client device 106 uses indications of future computing metric values for the processing devices 110-114 to determine whether one of the processing devices 110-114 should be removed from the processing group 108 as well as whether an additional processing device should be added to the processing group 108. In another example, the client device 106 uses the metric value data 128 to schedule batch workloads, perform maintenance on the processing devices 110-114, improve operational efficiency of the processing group 108, and so forth. In an example in which the processing group 108 is representative of cloud-based resource capacity, the metric value data 128 is usable for cloud-based resource allocation which includes physical resource allocation, virtual resource allocation, etc.

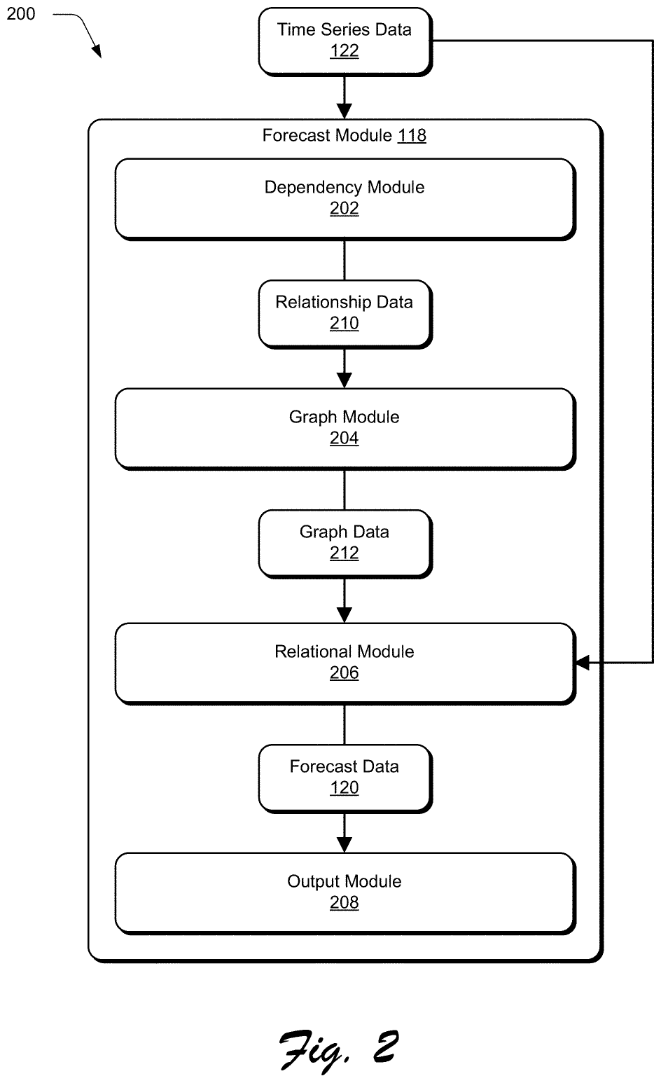

FIG. 2 depicts a system 200 in an example implementation showing operation of a forecast module 118. The forecast module 118 is illustrated to include a dependency module 202, a graph module 204, a relational module 206, and an output module 208. For example, the forecast module 118 receives the time-series data 122 as an input, and the time-series data 122 describes historic computing metric values of processing devices included in a group of processing devices.

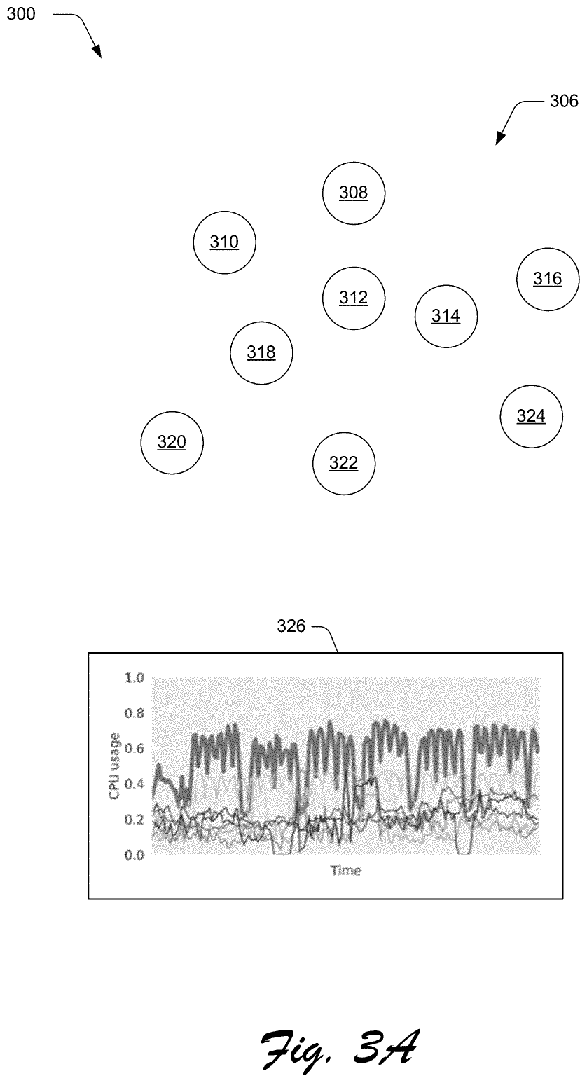

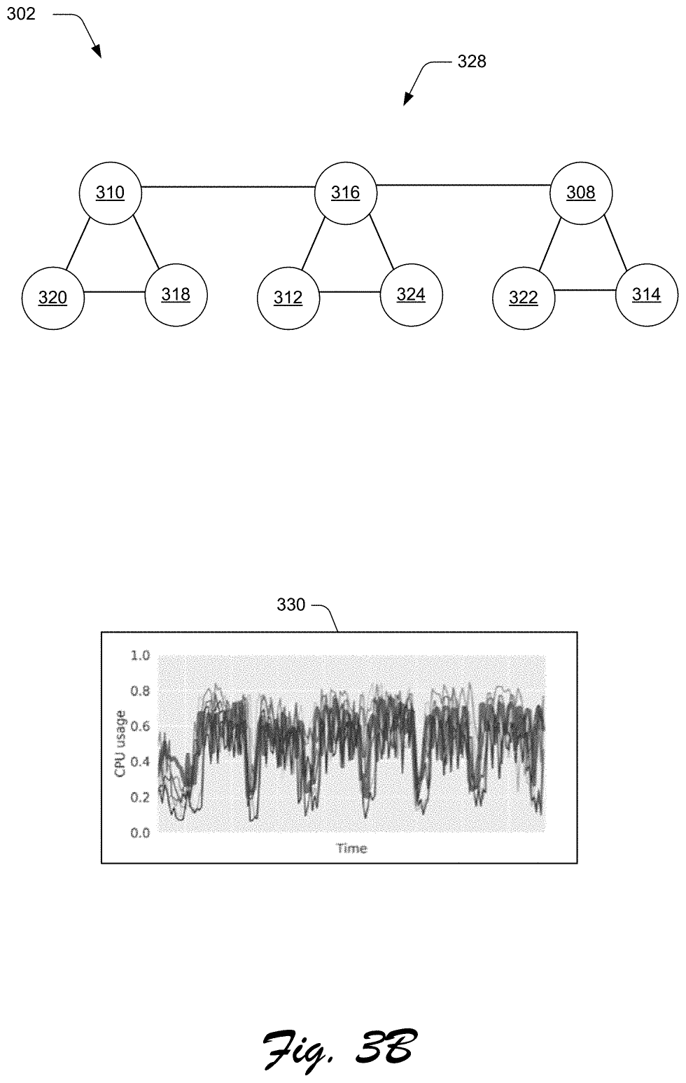

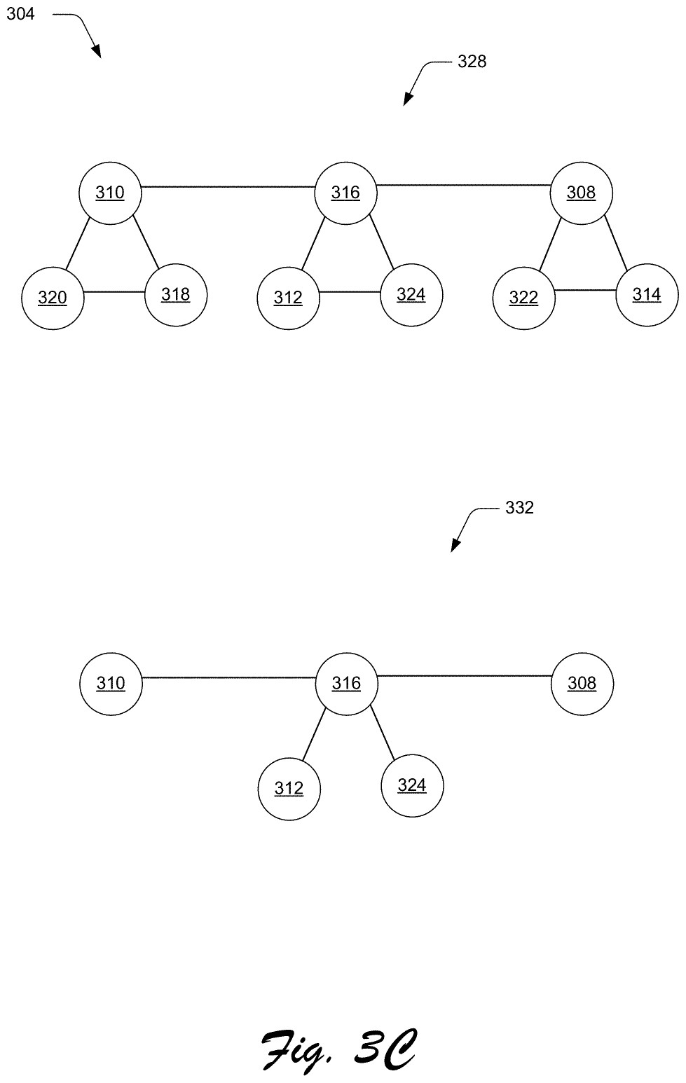

FIGS. 3A, 3B, and 3C illustrate an example of generating an indication of a future computing metric value for a particular processing device included in a group of processing devices. FIG. 3A illustrates a representation 300 of received time-series data 122. FIG. 3B illustrates a representation 302 of a graph having nodes representing processing devices that are connected based on dependency relationships between the processing devices included in the group of processing devices. FIG. 3C illustrates a representation 304 of a graph representing a first set of the time-series data 122 and a partial graph representing a second set of the time-series data 122.

The dependency module 202 receives the time-series data 122 which is illustrated in the representation 300 of FIG. 3A. As shown, the representation 300 includes unrelated processing devices 306. The unrelated processing devices 306 are represented by nodes 308-324 which each correspond to a processing device of the group of processing devices. Each of the nodes 308-324 also includes time-series data 122 of its corresponding processing device. As illustrated in the representation 300, the nodes 308-324 are disconnected and organized randomly or arbitrarily and without any relational information between the nodes 308-324.

This random and/or arbitrary organization of the nodes 308-324 is depicted in a time-series graph 326 which includes historic time-series data 122 for each of the nodes 308-324. As illustrated by the time-series graph 326, the historic time-series data 122 for the nodes 308-324 appears unrelated when the nodes 308-324 are organized as the unrelated processing devices 306. In this example, the time-series data 122 for any one of the nodes 308-324 appears to be unrelated to the time-series data 122 for each of the other nodes 308-324.

For example, the dependency module 202 processes the time-series data 122 to generate relationship data 210 that describes dependency relationships between processing devices represented by the nodes 308-324. The dependency module 202 determines dependency relationships by identifying sets of the nodes 308-324 which have similar time-series data 122. Consider an example in which the dependency module 202 determines whether nodes 308, 310 have a dependency relationship. In this example, the dependency module 202 compares the time-series data 122 of the node 308 with the time-series data 122 of the node 310. If the nodes 308, 310 have similar time-series data 122 (e.g., CPU usage values of processing devices represented by the nodes 308, 310 increase and decrease in close temporal proximity and by similar amounts), then the dependency module 202 determines that the nodes 308, 310 have a dependency relationship. If the nodes 308, 310 have dissimilar time-series data 122 (e.g., changes in CPU usage values of the processing device represented by the node 308 are unrelated to changes in CPU usage values of the processing device represented by the node 310), then the dependency module 202 determines that the nodes 308, 310 do not have a dependency relationship.

In one example, the dependency module 202 determines dependency relationships between the nodes 308-324 using a radial basis function kernel for time-series data 122 of nodes i and j which is representable as:

$$K ( {z}_{i} , {z}_{j} ) = exp ( - \frac{{‖ {z}_{i} - {z}_{i} ‖}^{2}}{2 {l}^{2}} )$$

where: K(zᵢ,zⱼ) represents a similarity between node time-series i and j; l represents a length scale of the kernel; and ∥zᵢ−zⱼ∥² represents a squared Euclidean distance between the node time-series i and the node time-series j.

In another example, the dependency module 202 determines dependency relationships between the nodes 308-324 using any similarity function. In this example, the described radial basis function kernel is one example of a particular similarity function and the described systems and techniques are not limited to use of the described radial basis function kernel.

For example, the dependency module 202 generates the relationship data 210 as describing the similarities between the time-series data 122 included in the nodes 308-324. In this example, the similarities between the time-series data 122 define dependency relationships between the nodes 308-324. The graph module 204 receives the relationship data 210 and processes the relationship data 210 to generate graph data 212. To do so, the graph module 204 forms a graph having the nodes 308-324 which are connected based on the dependency relationships.

In one example, if a first and second node of the nodes 308-324 have a dependency relationship based on time-series data 122 of the first and second nodes, then the graph module 204 connects the first and second nodes in the graph. In this example, if the first and second nodes do not have a dependency relationship based on the time-series data 122 of the first and second nodes, then the graph module 204 does not connect the first and second nodes in the graph. As shown in FIG. 3B, the representation 302 includes a graph 328 having the nodes 308-324 which are connected based on the dependency relationships.

As illustrated, the processing device represented by the node 310 has a dependency relationship with a processing device represented by node 316. The processing device represented by the node 310 also has a dependency relationship with a processing device represented by node 318 and a dependency relationship with a processing device represented by node 320. The processing device represented by the node 320 has a dependency relationship with the processing device represented by the node 310 and with the processing device represented by the node 318. Similarly, the processing device represented by the node 318 has a dependency relationship with the processing device represented by the node 310 and with the processing device represented by the node 320.

The processing device represented by the node 316 has a dependency relationship with the processing device represented by the node 310. The processing device represented by the node 316 also has a dependency relationship with the processing device represented by the node 308, a processing device represented by node 312, and a processing device represented by node 324. The processing device represented by the node 312 has a dependency relationship with the processing device represented by the node 316 and with the processing device represented by the node 324. In a similar manner, the processing device represented by the node 324 has a dependency relationship with the processing device represented by the node 312. The processing device represented by the node 324 also has a dependency relationship with the processing device represented by the node 316.

The processing device represented by the node 308 has a dependency relationship with the processing device represented by the node 316, a processing device represented by node 322, and a processing device represented by node 314. The processing device represented by the node 322 has a dependency relationship with the processing device represented by the node 308 and a dependency relationship with the processing device represented by the node 314. Similarly, the processing device represented by the node 314 has a dependency relationship with the processing device represented by the node 322 and a dependency relationship with the processing device represented by the node 308.

Although edges connecting the nodes 308-324 of the graph 328 are described as being representative of dependency relationships between processing devices represented by the nodes 308-324, it is to be appreciated that these edges are equally capable of representing other relationships between the processing devices. For example, the edges connecting the nodes 308-324 represent similar geographies in which the processing devices are physically located. In one example, the edges connecting the nodes 308-324 represent similar types of processing devices such as by connecting nodes that represent processing devices with the same or similar serial number or lot number of a manufacturer of the processing devices. In another example, the edges connecting the nodes 308-324 represent similar scheduled maintenance cycles for the processing devices, similar hardware implementations of the processing devices, and so forth.

In the illustrated example, the graph 328 is static such that forecast module 118 generates the graph 328 and leverages the graph 328 for forecasting. In other examples, the graph 328 is dynamic and the forecast module 118 updates the graph 328 in response to receiving updated time-series data 122. In these examples, the forecast module 118 leverages the updated graph 328 for forecasting which increases accuracy of the forecasts. In one example, the updated graph 328 includes updated nodes and/or edges connecting nodes based on updated dependency relationships described by the updated time-series data 122.

The graph 328 organization of the nodes 308-324 is depicted in a time-series graph 330 which includes historic time-series data 122 for each of the nodes 308-324. As shown, the historic time-series data 122 of the nodes 308-324 appears highly correlated when the nodes 308-324 are organized in the graph 328. This is because the graph 328 has a structure which encodes the dependency relationships between the processing devices represented by the nodes 308-324. For example, the graph module 304 generates the graph data 212 as describing the graph 328.

The relational module 206 receives the graph data 212 and the time-series data 122 and processes the graph data 212 and/or the time-series data 122 to generate forecast data 120. In an example, the relational module 206 includes a relational global model and a relational local model and each of these models leverage the graph 328 for forecasting computing metric values. In this example, the relational module 206 generates a parametric distribution to predict future computing metric values using a hybrid model which is a combination of the relational global model and the relational local model.

To generate the parametric distribution, the relational global model learns non-linear time-series patterns globally using time-series data 122 of all of the connected nodes 308-324 of the graph 328. The relational global model employs an adjacency matrix of the graph 328 for learning relational global factors that represent the non-linear time-series patterns. In one example, the relational global model includes a graph convolutional recurrent network model. In another example, the relational global model includes a diffusion convolutional recurrent neural network model. In an additional example, the relational global model includes a recurrent neural network model.

The relational local model learns individual probabilistic models for each of the nodes 308-324 based on time-series data 122 of each of the nodes 308-324 and time-series data 122 of nodes connected to each of the nodes 308-324 in the graph 328. In one example, the relational local model learns a probabilistic model for the node 308 using the time-series data 122 of the node 308 as well as the time-series data 122 of nodes 314, 316, 322. In another example, the relational local model learns a probabilistic model for the node 316 using time-series data 122 of the node 316 in addition to time-series data 122 of nodes 308, 310, 312, and 324. In an example, the relational local model includes a recurrent neural network model. In an additional example, the relational local model includes a probabilistic graph convolutional recurrent network model.

To generate the forecast data 120, the relational module 206 processes a first set of the time-series data 122 using the relational global model and the relational module 206 processes a second set of the time-series data 122 using the relational local model. For example, the relational module 206 determines the first set of the time-series data 122 and the second set of the time-series data 122 based on the structure of the graph 328. This is illustrated in the representation 304 of FIG. 3C with respect to the node 316. As shown, the first set of the time-series data 122 includes time-series data 122 of all connected nodes of the graph 328. The second set of the time-series data 122, for example with respect to the node 316, includes the time-series data 122 of the node 316 and the time-series data 122 of nodes of the graph 328 connected to the node 316. This is illustrated as a local relational graph 332 for the node 316.

The relational module 206 generates a first output by processing the first set of the time-series data 122 using the relational global model and generates a second output by processing the second set of the time-series data 122 using the relational local model. The relational module 206 generates the forecast data 120 by combining outputs of the relational global model and the relational local model. For example, the forecast data 120 describes a probabilistic forecast of future computing metric values for the processing devices represented by the nodes 308-324. The output module 208 receives the forecast data 120 and leverages the forecast data 120 to generate metric value data 128 that describes an indication of a future computing metric value of a particular processing device of the processing devices represented by the nodes 308-324. In an example, the output module 208 generates the metric value data 128 responsive to the computing device 102 receiving request data 126 describing a request for the future computing metric value of the particular processing device.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

Example Procedures

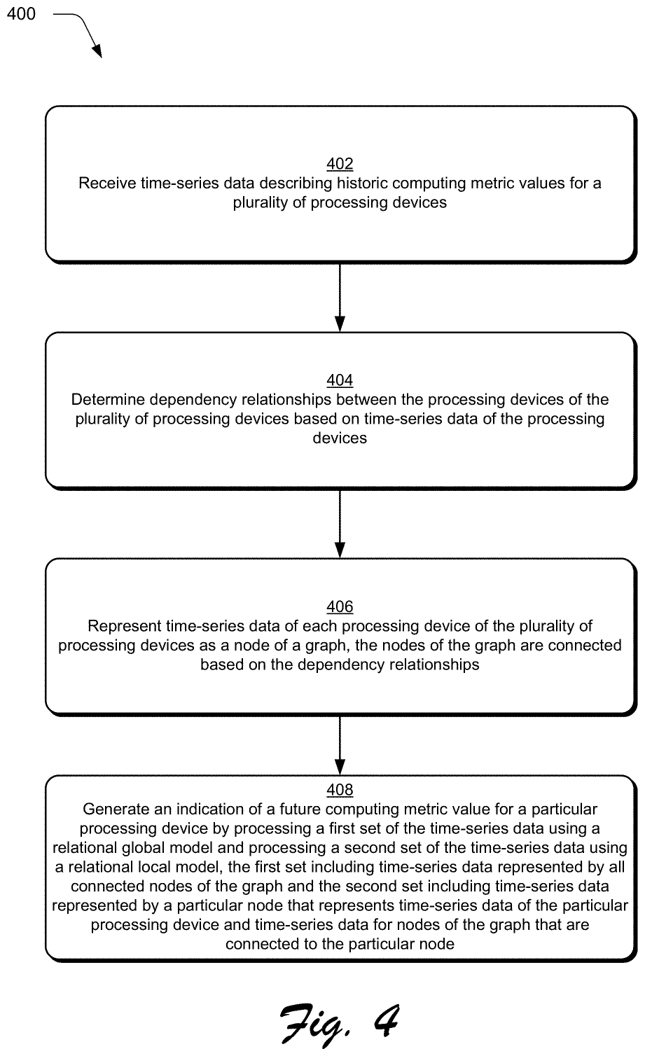

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-3. FIG. 4 is a flow diagram depicting a procedure 400 in an example implementation in which time-series data is received describing historic computing metric values for a plurality of processing devices and an indication of a future computing metric value for a particular processing device is generated.

Time-series data describing historic computing metric values for a plurality of processing devices is received (block 402). For example, the computing device 102 implements the forecast module 118 to receive the time-series data. Dependency relationships are determined between processing devices of the plurality of processing devices based on time-series data of the processing devices (block 404). The forecast module 118 determines the dependency relationships between the processing devices in one example.

Time-series data of each processing device of the plurality of processing devices is represented as a node of a graph, and the nodes of the graph are connected based on the dependency relationships (block 406). In one example, the computing device 102 implements the forecast module 118 to represent time-series data of each processing device as a node of the graph. An indication of a future computing metric value for a particular processing device is generated by processing a first set of the time-series data using a relational global model and processing a second set of the time-series data using a relational local model, the first set including time-series data represented by all connected nodes of the graph and the second set including time-series data represented by a particular node that represents time-series data of the particular processing device and time-series data for nodes of the graph that are connected to the particular node (block 408). In one example, the forecast module 118 generates the indication of the future computing metric value for the particular processing device.

Example Improvements

The described systems were evaluated against a baseline system on two different datasets for performing forecasting tasks including one-step ahead forecasting and multi-step ahead forecasting. Dataset 1 includes trace dataset recordings of activities of a cluster of 12,580 machines for 29 days since 19:00 EDT on May 1, 2011. CPU and memory usage for each task are recorded every five minutes. Usage of tasks is aggregated to usage of associated machines resulting in a time-series of length 8,354. Dataset 2 includes trace dataset recordings of CPU and memory usage of 3,270 nodes from Oct. 31, 2018 to Dec. 5, 2018. This dataset has a timescale of 30 minutes resulting in a time-series of length 1,687. Table 1 presents statistics and properties of Dataset 1 and Dataset 2.

TABLE 1

| | | | | | | | | | | Median |
|---|---|---|---|---|---|---|---|---|---|---|
| | | | | Avg. | Median | Mean | | Time- | | CPU |
| Dataset | \|V\| | \|E\| | Density | Deg. | Deg. | wDeg. | D | scale | T | usage |
| 1 | 12,580 | 1,196,658 | 0.0075 | 95.1 | 40 | 30.3 | 5 | 5 min | 8,354 | 21.4% |
| 2 | 3,270 | 221,984 | 0.0207 | 67.9 | 15 | 67.7 | 5 | 30 min | 1,687 | 9.1% |

The baseline system evaluated was DeepFactors (“DF”) as described by Wang et al., Deep factors for forecasting, arXiv preprint arXiv:1905.12417, 2019. To ensure fair competition, DF was modified and the version of DF evaluated for comparison uses the same inputs as the described systems. The evaluation setup used 10 global factors with a long short-term memory (LSTM) cell of 1-layer and 50 hidden units in the global component and 1-layer and five hidden units (recurrent neural network) in the local component. Gaussian likelihood was used for random effects in the DF model. The Adam optimization method in Gluon was used with an initial learning rate as 0.001 to train the models. Only the most recent six values in the time-series data were used for training across all evaluations. The described systems and DF were evaluated with various forecast horizons including H={1, 3, 4, 5}.

In the following discussion, “GG” refers to the described systems having the relational global model implemented using a graph convolutional recurrent network model and the relational local model implemented using a probabilistic graph convolutional recurrent network model; “GR” refers to the described systems having the relational global model implemented using a graph convolutional recurrent network model and the relational local model implemented using a recurrent neural network model; and “RG” refers to the described systems having the relational global model implemented using a recurrent neural network model and the relational local model implemented using a probabilistic graph convolutional recurrent network model. Results are described for p={0.5, 0.9}, denoted as P50QL and P90QL, respectively.

GG is superior for Dataset 1 and Dataset 2 with P50QL and P90QL for one-step ahead forecasting. GG is also superior for Dataset 1 with P50QL for predictions 3 and 4 steps ahead. RG is superior for Dataset 1 with P50QL for predictions 5 steps ahead. GG is superior for Dataset 2 with P50QL for predictions 3, 4, and 5 steps ahead. GG is also superior for Dataset 1 and Dataset 2 with P90QL for predictions 3, 4, and 5 steps ahead.

Table 2 presents training runtime performance in seconds.

TABLE 2

| Sys- | | | | |
|---|---|---|---|---|
| tem | DF | GG | GR | RG |
| Data- | 315.06 ± 67.80 | 279.45 ± 41.19 | 222.08 ± 69.52 | 281.76 ± 49.51 |
| set 1 | | | | |
| Data- | 378.05 ± 441.64 | 282.30 ± 36.80 | 211.20 ± 21.56 | 264.86 ± 56.29 |
| set 2 | | | | |

As shown in Table 2, GR is superior for both Dataset 1 and Dataset 2. Table 3 presents inference runtime performance in seconds.

TABLE 3

| System | DF | GG | GR | RG |
|---|---|---|---|---|
| Dataset 1 | 8.28 ± 0.02 | 1.67 ± 0.03 | 0.99 ± 0.003 | 1.16 ± 0.003 |
| Dataset 2 | 2.12 ± 0.001 | 0.51 ± 0.005 | 0.28 ± 0.001 | 0.33 ± 0.000 |

As shown in Table 5, GR is superior for both Dataset 1 and Dataset 2.

Example System and Device

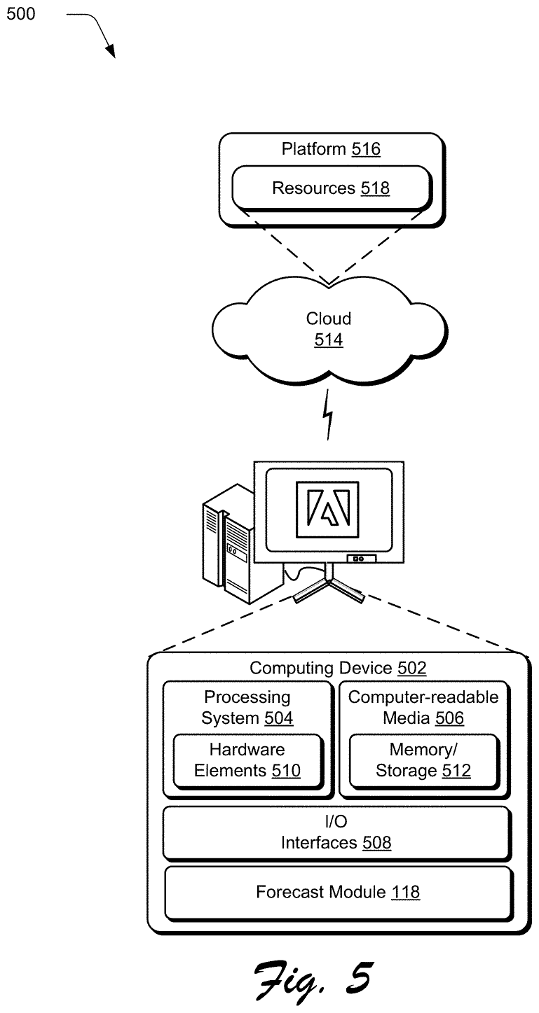

FIG. 5 illustrates an example system 500 that includes an example computing device that is representative of one or more computing systems and/or devices that are usable to implement the various techniques described herein. This is illustrated through inclusion of the forecast module 118. The computing device 502 includes, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that are be configured as processors, functional blocks, and so forth. This includes example implementations in hardware as an application specific integrated circuit or other logic device formed using one or more semiconductors. The hardware elements 510 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 506 is illustrated as including memory/storage 512. The memory/storage 512 represents memory/storage capacity associated with one or more computer-readable media. In one example, the memory/storage component 512 includes volatile media (such as random access memory (RAM)) and/or nonvolatile media (such as read only memory (ROM), Flash memory, optical disks, magnetic disks, and so forth). In another example, the memory/storage component 512 includes fixed media (e.g., RAM, ROM, a fixed hard drive, and so on) as well as removable media (e.g., Flash memory, a removable hard drive, an optical disc, and so forth). The computer-readable media 506 is configurable in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that that is accessible to the computing device 502. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 502, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 510. For example, the computing device 502 is configured to implement particular instructions and/or functions corresponding to the software and/or hardware modules. Accordingly, implementation of a module that is executable by the computing device 502 as software is achieved at least partially in hardware, e.g., through use of computer-readable storage media and/or hardware elements 510 of the processing system 504. The instructions and/or functions are executable/operable by one or more articles of manufacture (for example, one or more computing devices 502 and/or processing systems 504) to implement techniques, modules, and examples described herein.

The techniques described herein are supportable by various configurations of the computing device 502 and are not limited to the specific examples of the techniques described herein. This functionality is also implementable entirely or partially through use of a distributed system, such as over a “cloud” 514 as described below.

The cloud 514 includes and/or is representative of a platform 516 for resources 518. The platform 516 abstracts underlying functionality of hardware (e.g., servers) and software resources of the cloud 514. For example, the resources 518 include applications and/or data that are utilized while computer processing is executed on servers that are remote from the computing device 502. In some examples, the resources 518 also include services provided over the Internet and/or through a subscriber network, such as a cellular or Wi-Fi network.

The platform 516 abstracts the resources 518 and functions to connect the computing device 502 with other computing devices. In some examples, the platform 516 also serves to abstract scaling of resources to provide a corresponding level of scale to encountered demand for the resources that are implemented via the platform. Accordingly, in an interconnected device embodiment, implementation of functionality described herein is distributable throughout the system 500. For example, the functionality is implementable in part on the computing device 502 as well as via the platform 516 that abstracts the functionality of the cloud 514.

### CONCLUSION

Although implementations of systems for forecasting computing metric values have been described in language specific to structural features and/or methods, it is to be understood that the appended claims are not necessarily limited to the specific features or methods described. Rather, the specific features and methods are disclosed as example implementations of systems forecasting computing metric values, and other equivalent features and methods are intended to be within the scope of the appended claims. Further, various different examples are described and it is to be appreciated that each described example is implementable independently or in connection with one or more other described examples.

What is claimed is:

1. In a digital medium forecasting environment, a method implemented by a computing device, the method comprising:
receiving, by the computing device, time-series data describing historic computing metric values for a plurality of processing devices;
determining, by the computing device, dependency relationships between processing devices of the plurality of processing devices based on time-series data of the processing devices;
representing, by the computing device, time-series data of each processing device of the plurality of processing devices as a node of a graph, the nodes of the graph are connected based on the dependency relationships; and
generating, by the computing device for display in a user interface, an indication of a future computing metric value for a particular processing device by processing a first set of the time-series data using a relational global model and processing a second set of the time-series data using a relational local model, the first set including time-series data represented by all connected nodes of the graph and the second set including time-series data represented by a particular node that represents time-series data of the particular processing device and time-series data for nodes of the graph that are connected to the particular node.

2. The method as described in claim 1, wherein the historic computing metric values are CPU usage values of the plurality of processing devices or memory usage values of the plurality of processing devices.

3. The method as described in claim 1, wherein the relational global model includes a graph convolutional recurrent network model.

4. The method as described in claim 3, wherein the relational local model includes a recurrent neural network model.

5. The method as described in claim 3, wherein the relational local model includes an additional graph convolutional recurrent network model.

6. The method as described in claim 1, wherein the relational global model includes a diffusion convolutional recurrent neural network model.

7. The method as described in claim 6, wherein the relational local model includes a recurrent neural network model.

8. The method as described in claim 6, wherein the relational local model includes a graph convolutional recurrent network model.

9. The method as described in claim 1, wherein the relational global model includes a recurrent neural network model.

10. In a digital medium forecasting environment, a system comprising:
a dependency module implemented at least partially in hardware of a computing device to:
receive time-series data describing historic computing metric values for a plurality of processing devices; and
determine dependency relationships between processing devices of the plurality of processing devices based on time-series data of the processing devices;
a graph module implemented at least partially in the hardware of the computing device to represent time-series data of each processing device of the plurality of processing devices as a node of a graph, the nodes of the graph are connected based on the dependency relationships;
a relational module implemented at least partially in the hardware of the computing device to:
generate a global indication of a future computing metric value for a particular processing device by processing time-series data represented by all connected nodes of the graph using a relational global model; and
generate a local indication of the future computing metric value by processing time-series data represented by a particular node that represents time-series data of the particular processing device and time-series data represented by nodes connected to the particular node using a relational local model; and
an output module implemented at least partially in the hardware of the computing device to generate an indication of the future computing metric value by combining the global indication and the local indication.

11. The system as described in claim 10, wherein the historic computing metric values are CPU usage values of the plurality of processing devices.

12. The system as described in claim 10, wherein the relational global model includes a graph convolutional recurrent network model and the relational local model includes an additional graph convolutional recurrent network model.

13. The system as described in claim 10, wherein the relational global model includes a graph convolutional recurrent network model and the relational local model includes a recurrent neural network model.

14. The system as described in claim 10, wherein the relational global model includes a recurrent neural network model and the relational local model includes a graph convolutional recurrent network model.

15. One or more computer-readable storage media comprising instructions stored thereon that, responsive to execution by a computing device, causes the computing device to perform operations including:
receiving time-series data describing historic computing metric values for a plurality of processing devices;
determining dependency relationships between processing devices of the plurality of processing devices based on time-series data of the processing devices;
representing time-series data of each processing device of the plurality of processing devices as a node of a graph, the nodes of the graph are connected based on the dependency relationships; and
generating, for display in a user interface, an indication of a future computing metric value for a particular processing device by processing a first set of the time-series data using a relational global model and processing a second set of the time-series data using a relational local model, the first set including time-series data represented by all connected nodes of the graph and the second set including time-series data represented by a particular node that represents time-series data of the particular processing device and time-series data for nodes of the graph that are connected to the particular node.

16. The one or more computer-readable storage media as described in claim 15, wherein the relational global model includes a recurrent neural network model.

17. The one or more computer-readable storage media as described in claim 16, wherein the relational local model includes a graph convolutional recurrent network model.

18. The one or more computer-readable storage media as described in claim 16, wherein the relational local model includes an additional recurrent neural network model.

19. The one or more computer-readable storage media as described in claim 15, wherein the relational global model includes a graph convolutional recurrent network model and the relational local model includes an additional graph convolutional recurrent network model.

20. The one or more computer-readable storage media as described in claim 15, wherein the relational global model includes a graph convolutional recurrent network model and the relational local model includes a recurrent neural network model.
